(19) United States
(12) Patent Application Publication
(10) Pub. No.: US 2023/0327460 A1
(43) Pub. Date: Oct. 12, 2023

(54) ACTIVE BATTERY BALANCER USING SPARE CELL

(71) Applicant: Sehat Sutardja, Las Vegas, NV (US)

(72) Inventor: Sehat Sutardja, Las Vegas, NV (US)

(21) Appl. No.: 18/132,902

(22) Filed: Apr. 10, 2023

Related U.S. Application Data
(60) Provisional application No. 63/329,399, filed on Apr. 9, 2022.

(51) Int. Cl. H02J 7/00

(52) U.S. Cl. CPC H02J 7/0014; H02J 7/0047

(57) ABSTRACT

A battery and battery balancing system comprising a battery pack comprising two or more cells connected in series and a separate balancing cell, which is not series connected in the battery pack. The balancing cell is configured to be selectively switched into connection with one or more cells of the battery pack. A charging input is configured to accept a charging current from a power source to charge the battery pack. Two or more balancing cell switches, responsive to switch control signals, configured to selectively connect the balancing cell to a cell in the battery pack. A cell monitoring and switch control unit configured to monitor cell parameters during charging and generate the switch control signals, such that upon the monitoring determining that a cell in the battery pack is an underperforming cell, switching the balancing cell into connection with the underperforming cell to supplement the underperforming cell.

### 1. FIELD OF INVENTION

The innovation relates to battery packs and in particular to a method and apparatus for increasing lifespan and maintaining capacity of the battery pack over time.

### 2. BACKGROUND

Modern EV battery packs are equipped with a battery balancer circuit as part of the battery management system, commonly referred to as the BMS. The job of the battery balancer circuit is to ensure that every battery cell, which are stacked in series, has an equal state of charge. The BMS is active during charging of the battery pack and during use (discharge) of the battery pack. During the charge cycles, the BMS prevents overcharging the healthy cell(s) to prevent damage to the cells. Similarly, during discharge cycles, the BMS monitors the cell parameters and will stop charging to prevent a weak cell from being depleted beyond its ability to be recharged thus causing the battery pack to be non-functional, which is to say completely dead.

Under normal operation, discharging must stop when any cell first runs out of charge, resulting in a low voltage limit, even though other cells may still hold significant charge. Likewise, charging must stop when any cell reaches its maximum safe charging voltage. However, one cell is underperforming, it will reach full charge sooner then the other cells. When this occurs, charge is diverted from the underperforming to ground to allow the other cells which are not yet charged, to full charge. This waste charging power and generates heat, which further harms the underperforming cell, often further degrading the underperforming cell. Failure to do either may cause permanent damage to the cells, or in extreme cases, drive cells into reverse polarity, cause internal gassing, thermal runaway, or other catastrophic failures, such as fire. Each cell will have a different capacity, which translate to a different charge duration until it is at its maximum capacity.

The problem with prior art BMS system is the manner it achieves the goal of equal state of charge among the different battery cells in the series stack. Specifically, equal state of charge is achieved by simply discharging the cells which reached maximum voltage first until the voltage of all battery cells are equal. This means the capacity of the overall battery pack can be determined by the health of the weakest battery cell. If the cells are not balanced, such that the high and low charge cutoff are at least aligned with the state of the lowest capacity cell, the energy that can be taken from and returned to the battery will be limited. This reduces the total capacity of the pack, which is set by the weakest cell, because and underperforming cell, which may only reach 50% capacity, will limit performance of the entire battery pack.

The two most common type of cell balancing is passive balancing and active balancing. In passive balancing, energy is drawn from the most charged cell and dissipated as heat, usually through resistors. Passive balancing equalizes the state of charge at some fixed point usually by having all cells reaching 100% state of charge at the same time or by having all cells reaching minimum state of charge at the same time.

With active balancing, energy is drawn from the most charged cell and transferred to the least charged cells, usually through capacitor-based, inductor-based or DC-DC type converters. Active balancing attempts to redistribute energy from cells in the battery pack at full charge to those cells in the battery back with a lower state of charge. Due to inefficiencies, some energy is still wasted as heat.

While this may be acceptable for small, inexpensive battery packs for portable speakers or flashlights, other applications are greatly disadvantaged by this prior art battery charging and discharging system. Electric vehicles, and their battery packs, are one such application that suffers from the prior art BMS. For example, electric vehicle battery packs could have more than 200 cells in series. The act of down grading 199 cells to be at the state of a single weak cell is not desirable due to the resulting loss of overall battery pack capacity, which reduces driving distance, and performance.

### SUMMARY

To overcome the drawbacks of the prior art and provide additional benefits, disclosed is a battery and battery balancing system. In one embodiment, the system comprises a battery pack comprising one or more cells connected in series and a balancing cell, which is not series connected in the battery pack, but configured to be selectively switched into connection with one or more cells of the battery pack. Also part of this embodiment is a charging input to the battery pack such that the charging input is configured to accept a charging current from a power source to charge the battery pack. A cell monitoring and switch control unit is configured to monitor one or more cell parameters during charging and responsive to the monitoring, generate the switch control signals. Upon the monitoring determining that a cell in the battery pack is an underperforming cell, switching the balancing cell into connection with the underperforming cell to supplement the underperforming cell. Two or more balancing cell switches are also provided and are responsive to switch control signals. The balancing cell switches are configured to selectively connect the balancing cell to the underperforming cell in the battery pack.

In one embodiment, the one or more cell parameters are voltage and/or time of connection to the balancing cell. Current can also be monitor, but current monitor is more complex and uses power. The two or more balancing cell switches may comprise FETs. It is contemplated that the balancing cell may be connected in parallel with the underperforming cell. In addition, the balancing cell may be switched between two or more underperforming cells during a charge cycle.

In one configuration, the balancing cell comprise two or more balancing cells, each of which are switchably connected to a cell in the battery pack. In one embodiment, the balancing cell is configured to also connect to an underperforming cell during a battery pack discharge cycle.

Also disclosed is a method for supplementing a battery pack during a charging or discharging after initiating use of a battery pack. The use of the battery pack is charging or discharging of the battery pack and the battery pack comprises one or more series connected cells. During use of the battery pack, monitoring one or more cells for an underperforming cell, and responsive to detecting the underperforming cell, generating switch control signals which then, provides the switch control signals to one or more switches. Responsive to the switch control signals, switching a balancing cell into electrical connection with the underperforming cell. Thereafter, continuing to monitor the one or more cells of the battery pack.

In one embodiment, the underperforming cell is a cell with one or more parameters that are outside of a predetermined acceptable range. The one or more parameters are one or more of the following: voltage and time of connecting to the balancing cell. The underperforming cell will require connection to the balancing cell the most or for the longest duration. In one configuration the electrical connection is the balancing cell in a parallel connection with the underperforming cell. It is contemplated that the balancing cell comprises two or more balancing cells, and each of the two or more balancing cells may be connected to different underperforming cells of the battery pack. In one variation, during charging, switching occurs to connect the balancing cell to a most charged cell in the battery pack, to transfer charge from the most charged cell to a least charged cell in the battery pack.

In another method of operation, the system compensates for an underperforming cell in a multi-cell battery pack during charging or discharging of the battery pack by performing the following steps. Initiating a charge event or discharge event for the battery pack and monitoring one or more aspects of the battery pack or cells that form the battery pack for one or more cells that have cell parameters that are outside of an allowed parameter range. A cell that has parameters that are outside of an allowed parameter range are designated as underperforming cells. This method also identifies one or more cells that are underperforming cells and switches one or more switches to electrically connect at least one of the underperforming cells to a balancing cell. The balancing cell is associated with the battery pack and selectively electrically connectable through switching to establish an electrical connection to underperforming cells of the battery pack. Responsive to identifying more than one underperforming cell, switching the balancing cell between the underperforming cells to compensate multiple underperforming cells with one balancing cell.

This method may further comprise monitoring for additional underperforming cells and responsive to identifying additional underperforming cells, generate new switch control signals. In one embodiment, the switching is performed by one or more FET devices and the switching is controlled by switch control signals generated by a cell monitor. The balancing cell may comprise two or more balancing cells and the switching comprises switching a first balancing cell to a first underperforming cell and switching a second balancing cell to a second underperforming cell. In one embodiment, the balancing cell is connected in parallel with the underperforming cell. It is also contemplated that the balancing cell and switching operation may perform charge storage to store charge from a charged cell to an underperforming cell.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a block diagram of a multi-cell battery pack with a balancing cell and associated switching module.

FIG. 2 illustrates an exemplary connection arrangement with switching elements for a three cell main battery pack.

FIG. 3 illustrates a block diagram of a multi-cell battery pack with multiple balancing cells and associated switching module.

FIG. 4A illustrates a block diagram of a multi-cell battery pack with one or more balancing cells and associated with one or more cell groups of a battery pack.

FIG. 4B illustrates a block diagram of a multi-cell battery pack with one or more balancing cells and a cell group balancer connecting cell groups.

FIG. 4C illustrates a block diagram of a multi-cell battery pack with one or more balancing cells and a second embodiment of a cell group balancer connecting cell groups.

FIG. 5 illustrates an exemplary method of operation of the battery pack with associated battery cell(s).

### DETAILED DESCRIPTION

Disclosed herein is an improved method and system to achieve equal state of charge among the cells of a multiple cell battery pack. It is disclosed to add or place, one or more additional battery cells that could be switched into a parallel configuration to any of main cells that are connected in series.

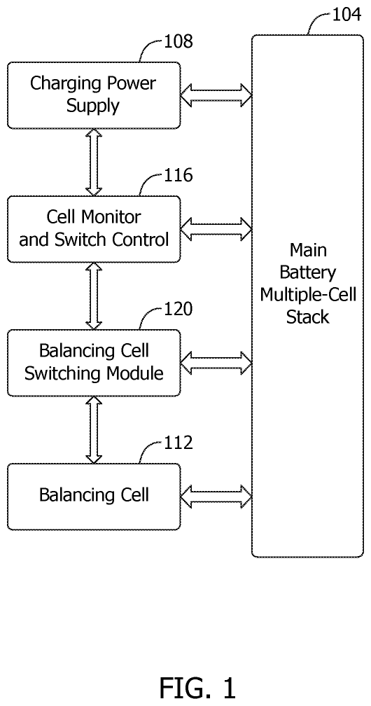

FIG. 1 illustrates a block diagram of a multi-cell battery pack with a balancing cell and associated switching module. This is but one possible switching system and as such, other configurations are contemplated. In this embodiment, a main battery 104 is provided that comprises multi-cell battery pack formed from two or more series connected cells. Charging power to the main battery 104 is provided by a charging power supply 108. The charging power supply 108 may comprise a battery charger or any other power source or a combination such as wireline power, solar, wind, tidal, chemical, generator or any other power source. The charging power supply 108 may also provide charging power to a balancing cell 112 either directly through a connection now shown, or through the main battery 104.

One or more cell monitors 116 are provided to monitor the state of each cell in the main battery 104 during charging and during discharge. This cell monitor and switch control (cell monitor) 116 may comprise one or more voltage comparators, current detectors, resistors, capacitors and other elements used to implement a battery charge/discharge monitoring system. The cell monitor 116 may also comprise a processor, capable of executing machine executable code, and memory configured to store machine executable code. The machine executable code would be configured to oversee cell monitoring during the charge and discharge cycle as well as generating the switch control signals. In one embodiment, the cell monitor 116 monitors the voltage of each cell (positive terminal in relation to ground or negative terminal) in relation to a cell target value and/or in relation to the other cells. Current into each cell may also be monitored. An electrical or other coupling between the cell monitor 116 and the main battery 104 is provided as shown. The cell data derived from the monitoring is provided to a balancing cell switching module 120 (switching module).

The switching module 120 comprises one or more switches or switching elements that are controlled by the monitoring data from the cell monitor 116. Responsive to the monitored cell data, the switching module 120 selectively switches the balancing cell 112 to make a connection with one or more cells in the main battery 104. The balancing cell 112 may be a electrical charge storage device which is the same as or different than the cells in main battery 104. It may be preferred to have the cells of the same type and capacity of the cells in the main battery 104. It is also contemplated that the balancing cell may be a super capacitor, which has a much longer lifespan although a lower charge capacity. In addition, the balancing cell could be of a higher quality or lifespan then the other cells in the battery pack for a longer lifespan. It is also contemplated that the balancing cell(s) may be replaceable independent of the main battery to further extend the life of the battery pack.

In one embodiment, the balancing cell 112 may be switched, by the switching module, into a parallel connection with a cell in the main battery 104, referred to as the supplemented cell(s). The balanced cell may be a cell that will benefit from having the balancing cell 112 in parallel during a charge or discharge cycle. It is also possible that the balancing cell 112 could also be connected in series, or the balancing cell may be connected to two or more main battery cells inside of a single cell. The supplemented cell (cell to which the balancing cell is connected) may change one or more times during the charging cycle and/or discharge cycle. The slower the rate of switching between cells or between connection to one cell, the less energy is lost due to switching power consumption. Exemplary methods of operation for a charge cycle and a discharge cycle are discussed below. Although FIG. 1 illustrates the elements in separate and discrete blocks, it should be understood that the various elements may be interspersed with other elements are in the main battery 104.

### Charge Cycle Operation

During an exemplary charge cycle, the charging power supply 108 provides charging power to the cells in the main battery 104. The cell monitor 116 monitors each cell's parameters during the charge cycle. Responsive to one or more of the cells reaching an overvoltage (maximum charge voltage) sooner than the other cells (indicating a lower capacity for such cells), the cell monitor 116 will switch the balancing cell into connection with the underperforming cell. This supplements the underperforming cell with the added capacity and charging capability of the balancing cell, which delays the time until it reaches full capacity (reaches overvoltage condition) thereby allowing the other cells to be charged to a higher capacity without having to simultaneously discharge and potentially harm the underperforming cell. In addition, the balancing cell also receives charge, allowing it to supplement underperforming cells during a discharge cycle. One goal is to have all the cells reach the same maximum voltage at the same time with each cell charged to each cell to maximum capacity. The balancing cell aids in that goal as described herein.

For example, a four cell main battery 104 may be undergoing charging, and each cell's maximum capacity is as follows: Cell1=96% of original capacity, Cell2=95% of original capacity, Cell3=77% of original capacity, and Cell4 97% of original capacity. In such a situation, the balancing cell may be switched into a parallel connection with the Cell3, thereby allowing the charge of the pack to continue with having to shunt current to ground or through a resistor which wastes power and generates heat. This delays the time until the maximum allowed voltage is researched for Cell3. Note that cell3 still only charges to 77% capacity but is not further taxed during charging due to being charged and having current dissipated away and from overheating. Charge time for the entire battery pack takes the same amount of time, namely until the other three cells exhibit maximum voltage (full charge). As a result, the battery pack can be charged up to 95%, the next lowest maximum charge capacity, which realizes an additional 18% of battery capacity. In addition, the balancing cell could be switched into a parallel connection with the next most underperforming cell as well.

During charging, the cells of the main battery are continuously monitored, and the balancing cell selectively connected to the lowest performance cell to allow the battery pack to be charged to the maximum degree without having the shunt charge from the underperforming cell to ground.

### Discharge Cycle Operation

A similar process as described above also occurs during a discharge cycle. During discharge, as power is drawn from the main battery 104, the status of each cell in the main battery 104 is monitored by the cell monitor to determine if any cell has too low of a voltage or too low of a remaining charge. Too low of a voltage is an indication that additional power should not be pulled from that cell or the cell can be damaged or made inoperable. Responsive to a particular cell in the main battery 104 having parameters which are outside of the allowable operating range, this cell can be deemed an underperforming cell. The switching module 120 can be controlled to switch in the balancing cell 112 to connect to the underperforming cell to thereby supplement its performance (increase the monitored voltage for that cell). Because current is now drawn from both the underperforming cell and the balancing cell, the two cells together are no longer deemed underperforming and the battery pack can continue to supply power beyond that previously possible.

### Switching Balancing Cell Between Multiple Cells in the Main Pack

In addition, it is also contemplated that the balancing cell 112 may be quickly switched between two or more underperforming cells in the main battery pack 104. For example, if two cells which form the main battery are both underperforming and either charging or discharging, then the switching module may rapidly switch the connection of the balancing cell between two or more cells in the battery pack. A switching FET may be used to establish and alternate the connection. It is also contemplated that the balancing cell 112 may be connected to two or more cells in the main battery 104 at the same time. In such a situation, the balancing cell may be more than one cell or a modified cell.

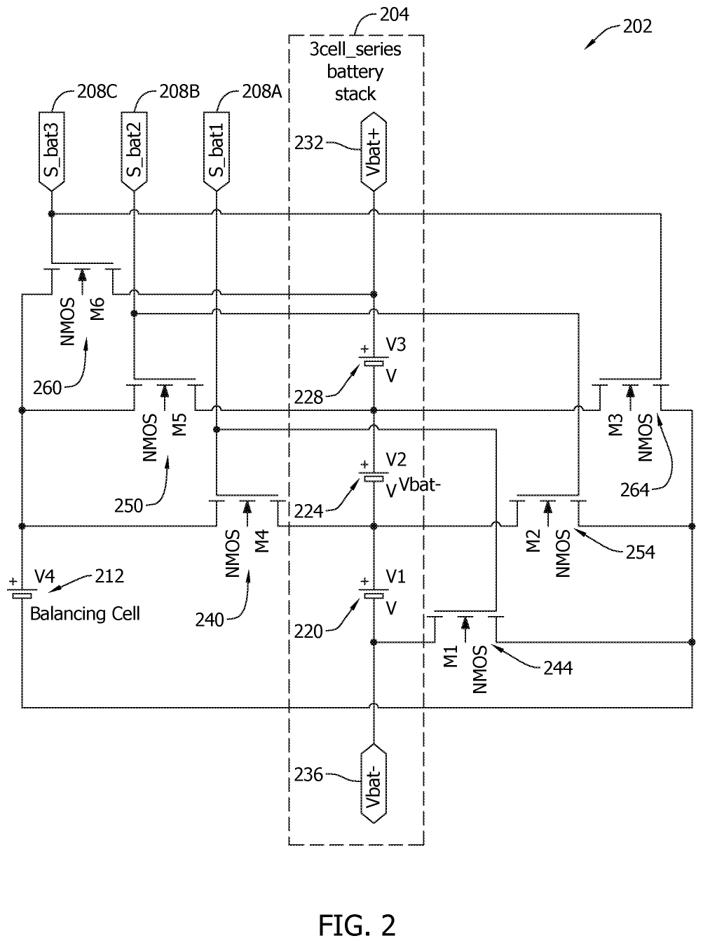

To aid in understanding, FIG. 2 illustrates an exemplary connection arrangement with switching elements for a three cell main battery pack. The enabling principles disclosed herein can be expanded to a greater (or fewer) number of cells, as would be understood by one of ordinary skill in the art. With a greater number of cells, the number of switches and switching complexity would increase. In FIG. 2, the main battery pack 204 includes three cells, namely the first cell 220, the second cell 224, and the third cell 228. Each of the cells 220, 224, 228 are connected in series as shown with a positive terminal of one cell connecting to a negative terminal of the adjacent cell. The ends of the main battery pack 204 comprise a positive battery pack terminal 232 and a negative battery pack terminal 236. A balancing cell 212 is also provided and it has a positive and negative terminal similar to the other cells 220, 224, 228 in the main battery pack 204 with a positive terminal and a negative terminal.

Three control signals are provided to the balancing system 202 shown in FIG. 2. The control signals comprise S_bat1 signal on S_bat1 terminal 208A, S_bat2 signal on S_bat2 terminal 208B, and S_bat3 signal on S_bat3 terminal 208C. The control signals S_bat1 signal, S_bat2 signal, and S_bat3 signal control the switches in balancing system 202 to selectively connect the balancing cell 212 to one or more of the cells in the main battery pack.

Numerous switching elements, enabled as FET switches in this embodiment, are distributed throughout the balancing system 202 of FIG. 2. Each control signal and associated switch is discussed. Control signal S_bat1 connects to switch 240 and switch 244 to force each switch closed thereby connecting the balancing cell 212 in parallel with cell 220. This may be referred to as parking the balancing cell with the underperforming cell. The term parking and switching are similar however parking is for longer periods of time while the term switching references to changing the balancing cell connection more often. The other switches 250, 254, 260, 264 are simultaneously open, thereby preventing the balancing cell 212 from connecting to the other cells 224, 228. When the balancing cell 212 is connected with the first cell 220, charging and discharging of the first cell is supplement by the balancing cell 212 thereby avoiding the pack from being undercharged, or from being considered as fully discharged when the other cells still have capacity.

Control signal S_bat2 is directed to switch 250 and switch 254 to force each switch closed thereby connecting the balancing cell 212 in parallel with the second cell 224. The other switches are simultaneously open, thereby preventing the balancing cell 212 from being connected to the other cells 224, 228. In this embodiment, when the control signal S_bat2 is active, the control signals S_bat1 and Sbat3 are inactive thereby assuming an open status and preventing connection of the balancing cell 212 to the first cell 220 and the third cell 228. Control signal S_bat3 connects to switch 260 and switch 264 to force both of these switches closed thereby connecting the balancing cell 212 in parallel with the third cell 228. The other switches are simultaneously open, thereby preventing the balancing cell 212 from being connected to the other cells 224, 220.

In operation, the cell monitor and switch controller shown in FIG. 1 monitors for and may detect an underperforming cell either during a charge cycle or a discharge cycle. Upon detection of an underperforming cell, the switch control circuitry generates controls signals S_bat1, S_bat2 and Sbat3 to selectively connect the balancing cell 212 to the underperforming cell. Thus, instead of shorting the properly performing cells to ground, the underperforming cell is supplemented by connecting to the balancing cell.

During a charge cycle, the underperforming cell will typically experience a high voltage condition, indicating that the charging must stop before the other cells are fully charged. With this innovation, the connection of the balancing cell to the underperforming cell prevents the unwanted high voltage condition of the underperforming cell, thereby allowing the other cells to reach a higher charge or full capacity. A similar situation occurs during the discharge cycle with the balancing cell supplementing the current draw of the underperforming cell, thereby preventing the cell monitor from stopping current flow from the battery pack when the other properly performing cells still have charge.

A further benefit of this topology is that healthy cells can assist the weak cells by moving charge from the healthy cells to the weak cells by switching the balancing cell back and forth between them. For example, referring to FIG. 1, if cell #3 has a 90% state of charge and cell #1 has an 80% state of charge, after several cycles of switching the spare cell between cell #3 and cell #1, both cells would eventually settle at 85% state of charge. The balancing cell may charge and discharge to transfer charge between the cells in the battery pack. Of course, the actual switching algorithm would be configured to take into account the health of the other cells in the series stack.

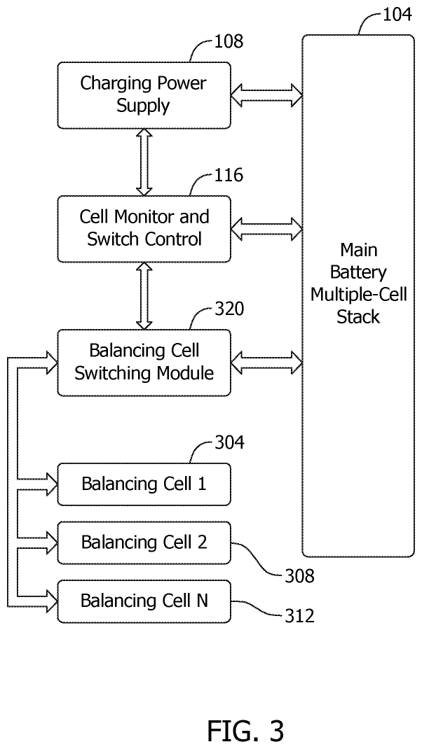

FIG. 3 illustrates a block diagram of a multi-cell battery pack with multiple balancing cells and associated switching module. As compared to FIG. 1, identical or similar elements are identified with identical reference numbers. In this embodiment, two or more balancing cells are provided to provide further balancing capabilities for the main battery 104. As shown, a first balancing cell 304, a second balancing cell 308, and a Nth balancing cell 312 are provided and connect to the balancing cell switching module 320. The balancing cell switching module 320 is configured to selectively switch the multiple cells 304, 308, 312 to connect to cells in the main battery 104. A similar cell monitoring and switching arrangement may be used as described above with the additional feature of additional switches and connections to connect the balancing cells to underperforming cells in the main battery 104. This embodiment is able to address the situation when more then one cell in the main battery 104 is underperforming without switching, or if numerous cells in the main battery 104 are underperforming, rapid switching of one balancing cell between several main battery cells may occur to allow one balancing cell to supplement more than one main battery cell. It is contemplated the typically one battery cell is sufficient, but additional balancing calls may benefit large battery packs.

For example, if the main battery 104 has a total of three hundred cells, there is a probability that two or more of the cells, over the lifetime of the battery pack, will become underperforming cells. This probability will vary with the type of cell, age of the main battery 104, quality/cost of the cells in the main battery, charging/discharging parameters, and operating environment. To extend the lifespan and charge capacity of main batteries with multiple cells, this embodiment provides enhanced balancing capability.

### Permanent Connection

A further benefit and switching capability is to permanently switch or park a balancing cell in parallel with or in the place of a main cell. Returning to the example of a main battery with 300 cells, if one or two cells fail, this could disable the entire main battery, requiring a full replacement or costly repair. Through the use of this innovation to permanently park (connect through switching) a balancing cell to the failed cell, the battery packs can be saved. This results in substantial cost savings for the user, as well as reduced harm to the environment.

### Extending the Charge Balancing Across Cell Pack

In an actual semiconductor chip implementation of this charge balancing circuit, the cost of implementation would ultimately limit the maximum number of devices that could be balanced in a single series stack. This is because the cost of the semiconductor chip would exponentially increase with increasing transistor breakdown voltage tolerances. As a result, it would be cost prohibitive to balance the charges in a single EV battery pack supporting a 900 volt voltage capability using only a single chip device due to the large size of the semiconductor based switches required for a 900 V switching environment.

To overcome this implementation challenge, it is proposed to split the charge balancing and main battery to multiple lower voltage battery pack (such as 24V or 48 GV battery pack). Balancing across battery packs could be achieved by adding an extra pair of switches that could be connected to the lowest cell in the next higher battery pack. The assumption is that any state of battery pack imbalance would be most likely smaller than the cell imbalance inside a battery pack since each battery pack is already individually balanced by the charge balancing action of the spare battery algorithm described above. As a result, the effective amount of battery pack imbalance is more likely to be a much smaller percentage of the individual cell imbalance. This extra pair of switches in the battery balancer circuitry enables a simple bucket brigade charge balancing (charge from one sub-pack transfer to next sub-pack and so one) to be used across the different battery packs. Note that bucket brigade charge balancing method only requires the switching chip to have only at most 4.2V extra headroom for the transistor breakdown voltage.

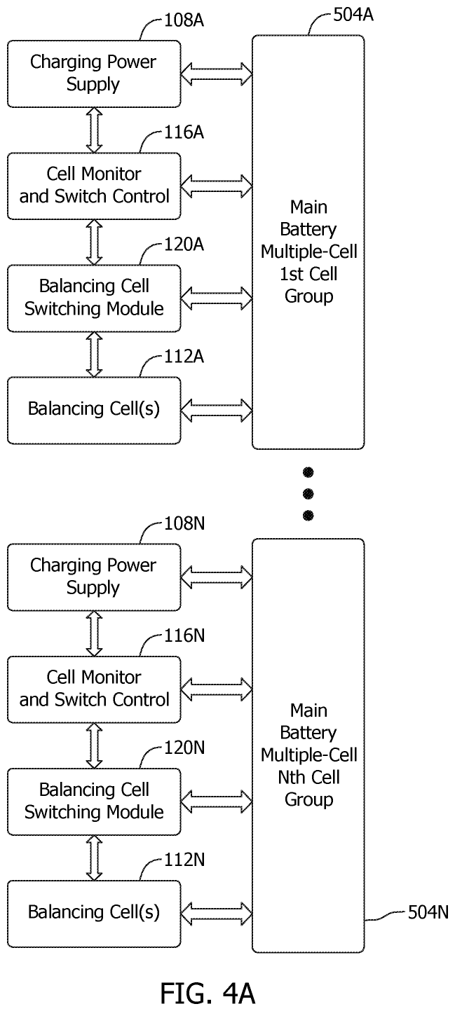

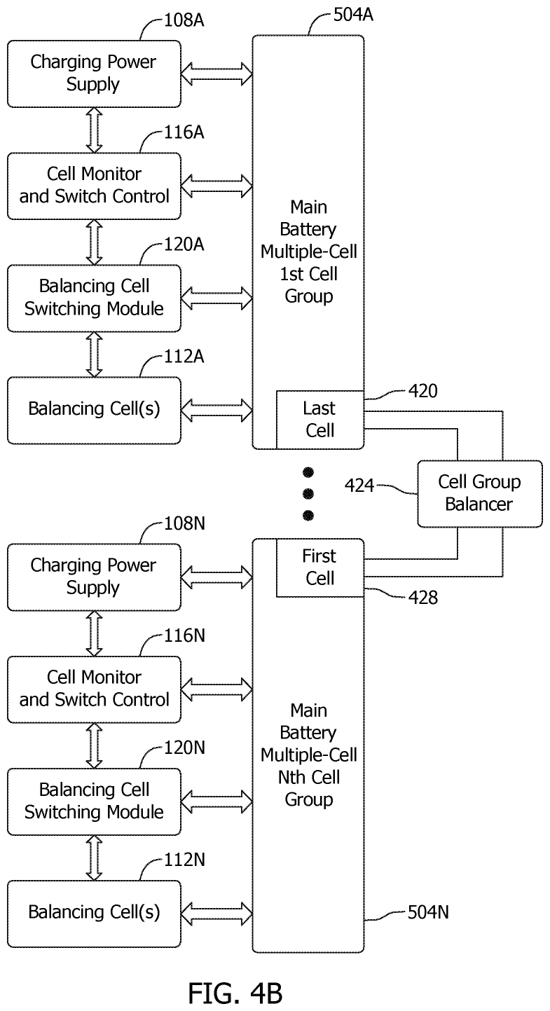

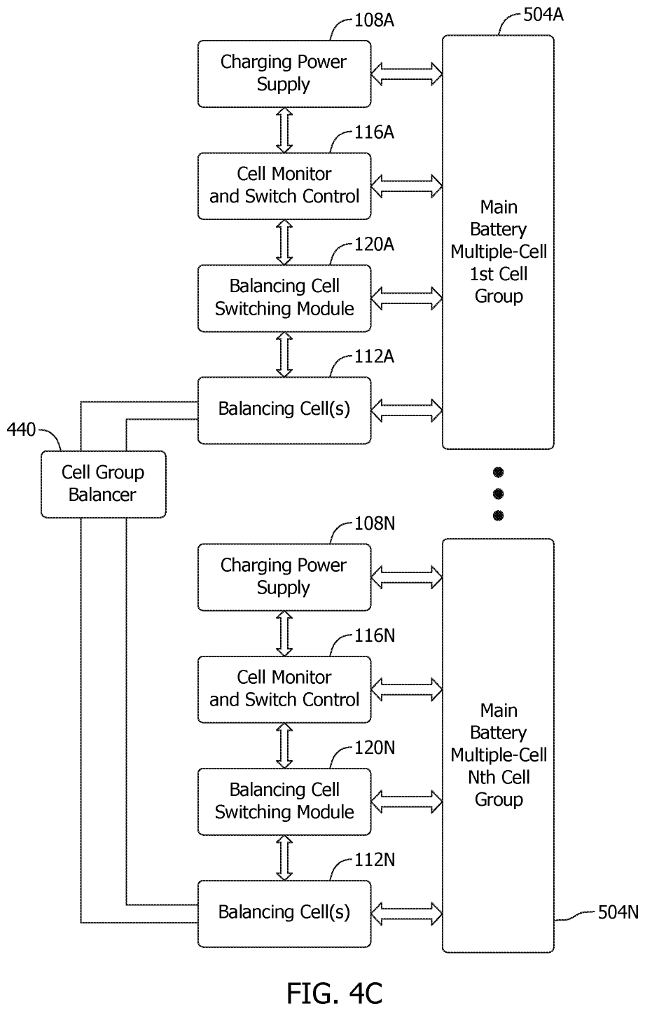

FIG. 4A illustrates a block diagram of a multi-cell battery pack with one or more balancing cells and associated with one or more cell groups of a battery pack. This is but one possible example embodiment, and based on this embodiment, one of ordinary skill in the art may arrive at other embodiments. In FIG. 4A, similar elements as compared to FIG. 1 are labeled with identical reference numbers. In this embodiment, the main battery is separated or divided into cell groups, such as a first cell group 504A up to an Nth cell group 504N where N can be any whole number. One or more balancing cells 112 are associated with each cell group 504A, 504N. Operation of the system shown in FIG. 4 is generally similar to that described for FIGS. 1, 2, and 3. However, the balancing cell can only be switched into a connection with the cells in the cell group with which it is associated. For example, balancing cells 112A can only connect to the first cell group 504A. The different cell groups 504A . . . 504N are typically electrically connected (not shown) to form a larger battery pack.

This provides the benefit of reducing the complexity of the balancing cell switching module 120A and the associated monitoring and switch control system 116A. In the above mentioned example environment of a 300 cell battery pack, separating the 300 cells into six groups of 50 cells, or 15 groups of 20 cells will greatly reduce complexity of the monitoring system 116 and the switching system 120. In addition, it also provides a greatly likelihood of having a balancing cell dedicated to an underperforming cell when a fewer number of main battery cells are assigned to a limited number of balancing cells.

FIG. 4B illustrates a block diagram of a multi-cell battery pack with one or more balancing cells and a cell group balancer connecting cell groups. As compared to FIG. 4A, identical or similar elements are labeled with identical reference numbers. This embodiment is generally similar to the embodiment of FIG. 4A with the addition of a cell group balancer 424 that connects between a last cell 420 of a first cell group 504A and the first of a subsequent cell group, such as in this embodiment the Nth cell group 504N. A cell group balancer 424 may connect between other cell groups, such as the other cell groups that may be located between cell group 504A, 504N. The cell group balancer may be configured with elements 116A, 120A, and 112A.

The cell group balancer is configured to move charge between cell groups. The balancing cell switching module 120A, 120N is configured to balance cells within a cell group, while the cell group balancer is configured to transfer charge between cell groups to thereby balance cell groups. Charge can be transferred from the last cell 420 to the first cell 428, or from the first cell 428 to the last cell 420. Based on the high likelihood that cells in the cell groups will be balanced due to the balancing cell 112A, 112N, then the cell groups will likely also be balanced. However, additional balancing between cell groups may be beneficial. The better internally balanced each cell group is, the more likely each cell group will be balanced as compared to other cell groups. Statistically, it is the law of large numbers that applies such that if a main battery contains a larger number of batteries, then statistically there will be a smaller standard of deviation from cell group to cell group. In one example situation, if cell group has more charge than an adjacent cell group, then charge can be transferred to the next cell group and then, within the cell group receiving the charge, the charge may be distributed between cells in the cell groups.

The cell group may increase the required switches by one pair. Control signals may be provided from the cell monitors 116A, 116N to the cell group balancer 424 to provide input regarding the stage of charge of each cell group 504A, 504N. In one embodiment the cell group balancer 424 includes a balancing cell while in other embodiment a balancing cell is not included.

It is also contemplated that a balancing cell on one cell group may be switched into an electrical connection with one of the cells of another cell group. For example, the balancing cell 120N could be switched into an electrical connection with the last cell 420 of the first cell group 504A.

FIG. 4C illustrates a block diagram of a multi-cell battery pack with one or more balancing cells and a second embodiment of a cell group balancer connecting cell groups. As compared to FIGS. 4A and 4B, identical or similar elements are labeled with identical reference numbers. This embodiment is generally similar to the embodiment of FIGS. 4A and 4B with the cell group balancer 440 instead connected to the balancing cells 112A 112N as shown. This arrangement allow allows transfer of charge or energy between cell groups through the balancing cells.

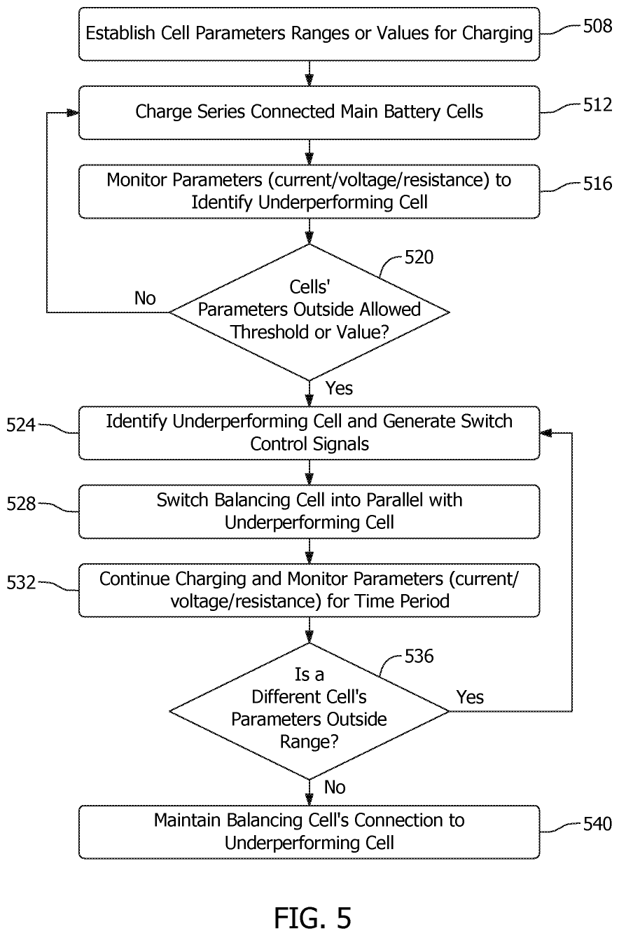

FIG. 5 illustrates an exemplary method of operation of the battery pack with associated battery cell(s). This is but one possible method of operation and variations from this method of operation are possible. In this method of operation, at a step 508 the cell monitoring module is established with cell parameter ranges or values for charging (and discharging). This embodiment is presented in relation to a charge cycle, but similar operational steps would occur during a discharge cycle. The cell parameters may include cell type and capacity, cell voltage, maximum charging current and/or voltage for the cell, maximum discharging current and/or voltage for the cell or any other charging or discharging parameter that is associated with the cell. These parameters or ranges are used during cell monitoring to determine if a cell should be deemed an underperforming cell. An underperforming cell is a cell that has one or more characteristics which are outside or beyond the allowable cell parameters.

At a step 512 charging occurs on the series connected main battery cells, as is understood in the art. At a step 516, the cell monitor and switch control module monitors the charging parameters for each cell to identify underperforming cells. The monitored parameters may comprise one or more of cell current, voltage, or resistance. At a decision step 520 a determination occurs if any of the parameters of a particular cell in the main battery is outside of the allowed range or value. If the cells' parameters are all in range, then the operation returns to step 512 and charging continues.

Alternatively, if a cell's parameters are outside of the allowed range, then the operation advances to step 524. At step 524 the underperforming cell is identified, and switch control signals are generated. At a step 528, the switch control signals activate one or more switches to connect the balancing cell to the underperforming cell, such as by connecting the balancing cell in parallel with the underperforming cell. This allows the balancing cell to supplement the underperforming cell such as by accepting the charging current to prevent an overvoltage situation in the underperforming cell, which may stop charging of the entire pack.

Next, at a step 532 the charging of the battery pack continues, and the cells are monitored for any cells which are outside of the acceptable parameters. The underperforming cell is now paired with the balancing cell, thereby preventing risk of harm or overcharging of the previously underperforming cell. This may continue for a time period. Next, the operation advances to a decision step 536 to determine if the parameters of any other cell is outside the allowed range. If another cell's parameters are outside the allow range, then the operation returns to step 524 and the operational steps repeat as discussed above. The balancing cell may be permanently switched to the new underperforming cell, or the balancing cell may be rapidly switched between one or more cells which were previously designated as underperforming. The switching may occur such that at any given time slice, the spare cell could either be connected to a cell in the main battery (in reference to FIG. 3, cell #1, cell #2, or cell #3) but not all the cells at the same time.

Alternatively, if at decision step 536 the determination is made that no other cell is underperforming, then the operation returns to step 532 as shown the charging continues without change. As discussed above, a similar method would occur during the discharge cycle such that cell monitoring would occur to identify under performing cell.

### Optimal Excess Charge Moving Algorithm

It is also contemplated and disclosed that an algorithm may be used to move the excess charge from the healthiest cell to the weakest cell until the healthiest cell is no longer considered to be the healthiest or until the weakest cell is no longer considered to be the weakest. Eventually there will be multiple cells that are considered equally healthiest and/or equally weakest. To achieve this charge transfer, the balancing cell (spare cell) can be used as a charge transfer and storage cell such that excess charge from a highly charged cell is transferred to the balancing cell. From the balancing cell, the charge can be transferred to one or more underperforming cells. Under this principle of operation, the spare cell switching algorithm should only move as much excess charges from a group of the healthiest cells to the group of the weakest cells until they are no longer considered the healthiest and/or the weakest. This process is then repeated until all cells have equal state of charge. This prevents valuable charge in a battery from being wasted, such as by discharge through a resistor, and instead it is pushed into the balancing cell for use to aid an underperforming cell.

### Aging Cells

In a series connected battery pack, a single cell could age at a faster rate compared to its peer. In such a situation, another algorithm or balancing approach is to not charge the prematurely aging cell to its fullest possible capacity, which may further accelerate its aging process. The prematurely aging cell would intentionally be charged, during a charge cycle, to less than full charge. Similarly, during discharge, the prematurely aging cell may not be discharged to the same level as the other cells. Instead, the balancing cell (spare cell) may be parked in parallel to the prematurely aging cell at least whenever the balancing cell is not used for cell balancing. This supplements the prematurely aging cell to prevent it from further accelerated aging delay due to excess current input/output of overvoltage situation that would accelerate cell parameter degradation due to aging. In another embodiment, the aging cell can be prepared to not be fully charged by parking the spare cell at least most of the time during charging to limit the charging current of the weakest cell.

In case there are multiple prematurely aging cells, the balancing cell (spare cell) could be parked at these cells with weighted duty cycle control to thereby allow the balancing cell to balance multiple prematurely aging cells. Alternatively multiple spare cells with independent switch control circuitry could be used. While increasing the number of balancing cells (spare cells) may at first be considered to greatly increase the complexity of the switching circuit, the increase in complexity is minimal. For example, doubling the number of spare cells only increases the number of circuit terminals of the spare cell control devices while maintaining the number of main battery cell terminals constant.

### Chip Size (Cost) Optimization

The shorting balancing cell switches shown in FIG. 2 could be optimized for lowest possible cost by realizing that not all of the switches would see the maximum possible voltages across them. For example, the switches in the middle of the series stack would experience approximately ½ of the maximum voltage (across the switch) that would be experienced by the lowest and highest battery cells in a series connected battery stack. As a result, the transistors (configured as switches) with the longest channel length and largest area would be used for the end point devices (switching cells at the end of the battery pack), which experience the highest voltage, and decreasingly smaller transistor devices for the switches toward the middle of the stack.

The equation R_{dson}/mm² defines the size (in millimeters squared) of the transistor device in relation to the turn on resistance of the device across the drain to source terminals of the device. The resulting size of a 60 volt device can easily be more than five times the value for Rdson/mm\hat{ }2 for a 30 volt device. Thus, smaller transistors can be used in the battery pack when a lower voltage is seen by the transistor, while larger transistors would typically be used for switching in the middle of the battery pack where higher voltages are seen. Conversely, large devices would be used when the voltage seen by the device is larger. This design adjustment using the proposed transistor selection and size optimization would reduce the overall chip size by up to 50%.

What is claimed is:

1. A battery and battery balancing system comprising:
a battery pack comprising two or more cells connected in series;
a balancing cell, which is not series connected in the battery pack, configured to be selectively switched into connection with one or none of the cells of the battery pack;
a cell monitoring and switch control unit configured to: monitor one or more cell parameters during charging, discharging, or both, responsive to the monitoring, generate the switch control signals, wherein upon the monitoring determining that a cell in the battery pack is an underperforming cell, switching the balancing cell into connection with the underperforming cell to supplement the underperforming cell; and
two or more balancing cell switches, responsive to switch control signals, configured to selectively connect the balancing cell to the underperforming cell in the battery pack.

2. The system of claim 1 wherein the one or more cell parameters are voltage and time of connection to the balancing cell.

3. The system of claim 1, further comprising a cell group balancer configured and connect to transfer charge between two different battery packs.

4. The system of claim 1 wherein the balancing cell switches comprises FETs.

5. The system of claim 1 wherein the balancing cell is connected in parallel with the underperforming cell.

6. The system of claim 1 wherein the balancing cell is switched between one or more underperforming cells during a charge cycle to transfer energy the one or more underperforming cells to a non-underperforming cell.

7. The system of claim 1 wherein the balancing cell is switched between two or more cells during a discharge cycle to transfer energy one or more non-underperforming cells to one or more the underperforming cells.

8. The system of claim 1 wherein the balancing cell comprises two or more balancing cells, each of which are switchable connectable to a cell in the battery pack.

9. The system of claim 1 wherein the balancing cell is configured to connect to an underperforming cell during a battery pack discharge cycle.

10. A method for supplementing a battery pack during a charging or discharging comprising:
initiating use of a battery pack, wherein the use is charging or discharging of the battery pack and the battery pack comprises two or more cells;
during use of the battery pack, monitoring one or more cells for an underperforming cell;
responsive to detecting the underperforming cell, generating switch control signals;
providing the switch control signals to one or more switches;
responsive to the switch control signals, switching a balancing cell into an electrical connection with the underperforming cell; and
continuing to monitor the one or more cells of the battery pack.

11. The method of claim 10 wherein the underperforming cell is a cell with one or more parameters that are outside of a predetermined acceptable range.

12. The method of claim 10 wherein the electrical connection is the balancing cell in a parallel connection with the underperforming cell.

13. The method of claim 10 wherein the balancing cell comprises two or more balancing cells, and each of the two or more balancing cells may be connected to different underperforming cells of the battery pack.

14. The method of claim 10 wherein during charging, switching occurs to connect the balancing cell to a most charged cell in the battery pack, to transfer charge from the most charged cell to a least charged cell in the battery pack.

15. A method for compensating for an underperforming cell in a multi-cell battery pack during charging or discharging of the battery pack comprising:
initiating a charge event or discharge event for the battery pack;
monitoring one or more aspects of the battery pack or cells that form the battery pack for one or more cells that have cell parameters that are outside of an allowed parameter range, thereby establishing the one or more cells as underperforming cells;
identifying one or more cells that are underperforming cells;
switching one or more switches to electrically connect at least one of the underperforming cells to a balancing cell, the balancing cell associated with the battery pack and selectively electrically connectable through switching to one or more underperforming cells of the battery pack; and
responsive to identifying more than one underperforming cell, switching the balancing cell between the underperforming cells to compensate multiple underperforming cells with one balancing cell.

16. The method of claim 15 further comprising monitoring for additional underperforming cells and responsive to identifying additional underperforming cell, generate new switch control signals.

17. The method of claim 15 wherein the switching is performed by one or more FET devices and the switching is controlled by switch control signals generated by a cell monitor.

18. The method of claim 15 wherein the balancing cell comprises two or more balancing cells and the switching one or more switches comprises switching a first balancing cell to a first underperforming cell and switching a second balancing cell to a second underperforming cell.

19. The method of claim 15 wherein switching one or more switches to electrically connect comprises connecting the balancing cell in parallel with the underperforming cell.

20. The method of claim 15 wherein the balancing cell performs charge storage and transfer to store charge from a charged cell and transfer it to an underperforming cell.
